(19) United States
(12) Patent Application Publication
(10) Pub. No.: US 2014/0133713 A1
(43) Pub. Date: May 15, 2014

(54) Method, Apparatus, and Computer-Readable Recording Medium for Authenticating a User

(71) Applicant: INTEL CORPORATION, Santa Clara, CA (US)

(72) Inventors: Daesung Kim, Guri-si (KR); Jihee Cheon, Seoul (KR)

(21) Appl. No.: 14/129,336

(22) PCT Filed: Dec. 28, 2012
(86) PCT No.: PCT/KR2012/011728

§ 371 Date: Jan. 28, 2014

(30) Foreign Application Priority Data
Dec. 29, 2011 (KR) 10 2011 0146346

(51) Int. Cl. G06K 9/00; G06F 21/32

(52) U.S. Cl. CPC G06K 9/00288; G06F 21/32
USPC 382/118

(57) ABSTRACT

Provided are a method, apparatus, and computer-readable recording medium for authenticating a user. The user authentication method includes scanning a face by operating a camera to obtain a scanned facial image, and comparing the scanned facial image with a facial image registered in a storage. Even if the scanned facial image is mismatched to the registered facial image, a password/pattern is requested. If an input password/pattern matches a registered password/pattern, a device can be unlocked. Additionally, the scanned facial image in the storage may be updated.

### TECHNICAL FIELD

The present disclosure relates to a method, apparatus, and computer-readable recording medium for authenticating a user. With respect to a device that can be unlocked through recognition of a registered facial image of a user, even when a user fails to be authenticated despite the user's scanned facial image, and thus fails to unlock the device, the user can be authenticated as an authorized user by inputting a password/pattern that matches a registered password/pattern stored in a storage. Authentication by the inputted password/pattern allows for the scanned user's facial image to be stored in the storage to update the stored registered facial image and be used to authenticate the user more accurately and effectively.

### BACKGROUND ART

Biometric recognition is a technology for recognizing different body features of persons, such as fingerprints, facial patterns, irises of eyes, etc., which may be used to authorize certain access, for example, to a device. Unlike keys or passwords, body features cannot be stolen or duplicated and do not run the risk of being changed or lost. Therefore, body features may be utilized within a security field.

In the biometric recognition field, face recognition technology includes a technology that detects a face region from a video or photograph image and identifies a facial pattern in the detected face region. Thus, in a smart phone or tablet personal computer (PC) space, face recognition may be applied to various applications, including for security purposes.

For face recognition technology generally applied to devices such as smart phones or tablet PCs, a facial region may be detected from a video or photograph image and the detected facial image may be compared with a facial image previously registered and stored, to authenticate a user and thereby unlock the respective device.

However, a scanned facial image may vary according to an ambient environment such as illumination, and thus, when comparing the scanned facial image with a registered facial image for authentication, the success rate of such authentication could be considerably reduced. Also, a face of the same user may vary as time passes or due to artificial makeup or cosmetic procedures. Thus, even though a facial image of a registered user (e.g., having a registered image in storage) is scanned, it is possible the authentication for the same registered user may fail.

In such case, to unlock a device, a user may need to reset the device, access a homepage or visit a service center to unlock the device. Therefore, it would take a long time for the user to unlock the device, which may be inconvenient for the user.

### DISCLOSURE OF INVENTION

### Technical Problem

The present disclosure provides various embodiments of a method, apparatus, and computer-readable recording medium for overcoming all of the above-described limitations occurring in the prior art.

### Solution to Problem

Various configurations of the present disclosure for achieving the objects of the present disclosure and realizing the characteristic effects of the present disclosure are as follows.

A storage for storing registered passwords/patterns and face information for each user is provided. When a user scans and inputs his/her facial image but it fails to be authenticated through a face recognition mechanism so that the device is not unlocked, the user may input a registered password/pattern of the user to unlock the device and a facial image may be newly scanned. In this case, the newly scanned facial image may be added to a facial image group associated with the user registered in the storage to update the registration profile, so as to considerably enhance a successful authentication rate in the future.

According to an aspect of the present disclosure, a user authentication method comprising: scanning a face by operating a camera to obtain a scanned facial image; comparing the scanned facial image with a facial image registered in a storage; if the scanned facial image matches the facial image registered in a storage, unlocking a user device; if there is a mismatch in the comparison, requesting a password/pattern; if the password/pattern matches a password/pattern registered in the storage in the comparison, unlocking a user device; and adding the scanned facial image to the storage to effect an update.

According to another aspect of the present disclosure, a user authentication apparatus includes: a storage device for storing a registered password/pattern and a registered facial image; a camera for scanning a face; a display unit for inputting a password/pattern and displaying a face authentication window and a password/pattern authentication window; and a control unit for providing the face authentication window to the display unit, operating the camera to scan the face and obtain a facial image of the scanned face, unlocking a device if the scanned facial image matches the registered facial image, providing the password/pattern authentication window to the display unit if the scanned facial image mismatches the registered facial image in, and upon inputting the password/pattern through the password/pattern authentication window, comparing the inputted password/pattern with the registered password/pattern to unlock the device if there is a match. Here, the control unit adds the scanned facial image to the storage to update the registered facial image.

According to another aspect of the present disclosure, a method is provided for authenticating a user that comprises (a) scanning a face by operating a camera to obtain a scanned facial image; (b) extracting characteristic information on the scanned facial image, comparing the extracted characteristic information with characteristic information on a facial image registered in a storage, and if there is a mismatch therebetween, requesting a password or a pattern; and (c) if the password or pattern matches a password or pattern registered in the storage in the comparison, unlocking a user device, and adding the characteristic information on the scanned facial image to the storage to effect an update. The method further provides wherein step (c) comprises (c1) if the password or pattern matches a password or pattern registered in the storage in the comparison, unlocking the user device; (c2) requesting approval from a user as to whether to add the characteristic information on the scanned facial image to effect an update; and (c3) upon receiving the user's approval, adding the characteristic information on the scanned facial image to the storage to effect an update.

If the password or pattern matches a password or pattern registered in the storage, the user device is unlocked, and an update is effected by replacing the characteristic information on the facial image registered in the storage with the characteristic information on the scanned facial image. Alternatively, if the password or pattern matches a password or pattern registered in the storage, unlocking the user device, and effecting an update by adding the characteristic information on the scanned facial image to a group of facial images registered in the storage.

In some embodiments the characteristic information comprises characteristic features, and in other embodiments the characteristic information comprises descriptors of the characteristic features.

Before step (a), in some embodiments, the password or pattern and the facial image in the storage are registered, wherein registering the password or pattern and the facial image in the storage comprises inputting the password or pattern n times and scanning the face at least m times to register the password or pattern and the face. Registering the password or pattern and the face in the storage may also comprise extracting characteristic information on the registered facial image and storing the characteristic information on the registered facial image in the storage.

According to another aspect of the present disclosure, an apparatus for authenticating a user is provided comprising a storage for storing a registered password or pattern and characteristic information on a registered facial image; a camera for scanning a face; a display unit for inputting a password or pattern and displaying a face authentication window and a password or pattern authentication window; and a control unit for providing the face authentication window to the display unit, operating the camera for authenticating a facial image inputted through the face authentication window by scanning the face and obtaining a facial image of the scanned face, extracting characteristic information on the scanned facial image, unlocking a device if the characteristic information on the scanned facial image matches the characteristic information on the registered facial image in comparison therebetween, providing the password or pattern authentication window to the display unit if the characteristic information on the scanned facial image mismatches the characteristic information on the registered facial image in comparison therebetween, and upon inputting the password or pattern through the password or pattern authentication window, comparing the inputted password or pattern with the registered password or pattern to unlock the device if there is a match therebetween in the comparison. The control unit may add the characteristic information on the scanned facial image to the storage to effect an update, and before effecting an update by adding the characteristic information on the scanned facial image to the storage, the control unit may display a message on the display unit, the message requesting approval from a user as to whether to add the characteristic information on the scanned facial image to effect an update, and upon receiving the user's approval, adds the characteristic information on the scanned facial image to the storage.

In some embodiments, if the password or pattern matches a password or pattern registered in the storage, the control unit unlocks the device, and an update is effected by replacing the characteristic information on the facial image registered in the storage with the characteristic information on the scanned facial image. Alternatively, if the password or pattern matches a password or pattern registered in the storage, the control unit may unlock the device, and an update is effected by adding the characteristic information on the scanned facial image to a group of facial images registered in the storage.

In some embodiments, the storage stores a user authenticating application and the control unit runs the user authenticating application if the user requests access to the user authenticating apparatus. In some embodiments, the control unit provides a user authentication setting window by running the user authenticating application and provides a function for registering the password or pattern and a function for registering the facial image through the user authentication setting window, and the display unit displays the user authenticating setting window and displays the function for registering the password or pattern and the function for registering the face.

The control unit may provide a password or pattern input window n times on the display unit if the function for registering the password or pattern is selected and stores the password or pattern in the storage as the registered password or pattern if the same password or pattern is inputted n times through the password or pattern input window, and the control unit may operate the camera and provide a face input window m times on the display unit if the function for registering a facial image is selected and extracts the facial characteristic information to store as the characteristic information on the registered facial image if the same face is inputted m times on the face input window.

In some embodiments, the apparatus may further include a transceiver for connecting to a user authenticating application providing server to download from the user authenticating application providing server that provides the user authenticating application.

In some embodiments, the characteristic information may comprise characteristic features. Alternatively, the characteristic information may comprise descriptors of the characteristic features.

According to another aspect of the present invention, a computer readable recording medium for storing a computer program thereon , when executed may implement any of the above methods.

### Advantageous Effects of Invention

According to the present disclosure, registered passwords/patterns and facial pattern information for a user may be stored in a storage device. If a user scans and inputs his/her facial image—for authentication to have access to a device but the user's scanned facial image is not a match with the registered facial pattern, then the user may be alternatively authenticated by entering a password/pattern that is a match to a registered password/pattern. Then, the device may be unlocked and the newly scanned facial image may be added to a registered facial image group so that the facial image group registered in the storage may be updated. Accordingly, in authenticating a user at a later time, a recent face of the user may be used for face authentication, thereby enhancing the authenticating success rate.

### BRIEF DESCRIPTION OF DRAWINGS

FIG. 1 is a block diagram illustrating a configuration of a user authentication apparatus according to an embodiment of the present disclosure.

FIG. 2 is a flowchart for describing a user authentication method according to an embodiment of the present disclosure.

FIG. 3 is a flowchart for describing an operation of registering a password/pattern according to an embodiment of the present disclosure.

FIG. 4 is a flowchart for describing a face registration operation according to an embodiment of the present disclosure.

### MODE FOR THE INVENTION

The present disclosure is described in detail with reference to the accompanying drawings in connection with specific embodiments in which the present disclosure can be implemented. The embodiments are described in detail in order for those having ordinary skill in the art to practice the present disclosure. It is to be understood that the various embodiments of the present disclosure differ from each other, but need not to be mutually exclusive. For example, a specific shape, structure, and characteristic described herein in relation to an embodiment can be implemented in another embodiment without departing from the spirit and scope of the present disclosure. It should be noted that the position or arrangement of each element within each disclosed embodiment can be modified without departing from the spirit and scope of the present disclosure. Accordingly, the following detailed description should not be construed as limiting the present disclosure. The scope of the present disclosure is limited by only the appended claims and equivalents thereof. The same reference numbers are used throughout the drawings to refer to the same parts.

Hereinafter, various embodiments of the present disclosure are described with reference to the accompanying drawings in order for those skilled in the art to be able to readily practice them.

As background, Korean Patent Publication No. 10-2004-67122 discloses a method for authenticating a user on the basis of a password and face recognition information, which allows an input of a password to effectuate the performance the face recognition or allows for a feedback mechanism that involves a face recognition and a subsequent recognition operation so that the probability of a failed authentication of a registered user or erroneously granting access to an unregistered user is reduced. However, even in a combination of a password and face recognition information method for authenticating a user, a successful authentication result requires the face recognition to be successful.

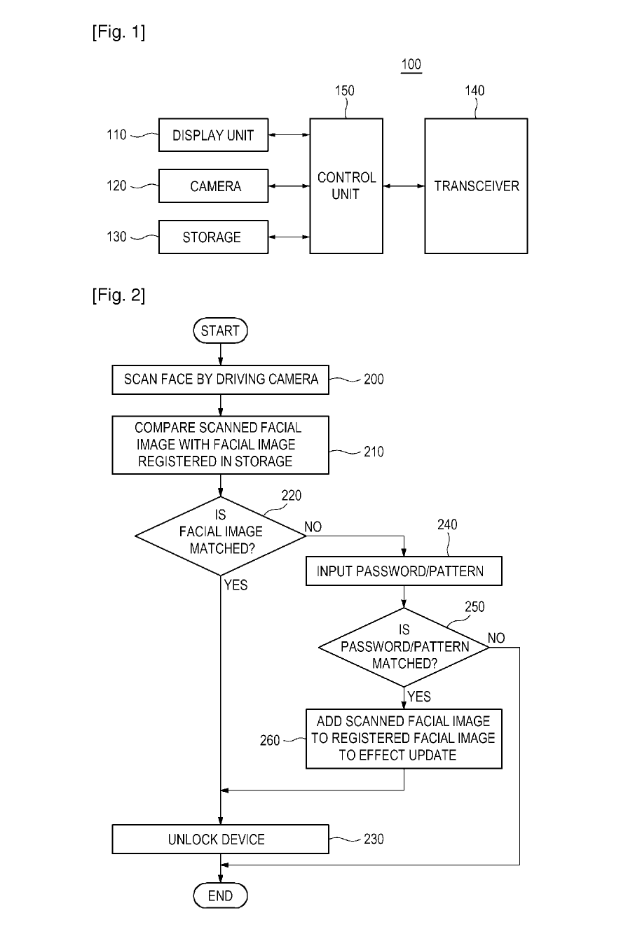

FIG. 1 is a block diagram illustrating a configuration of a user authentication apparatus 100 according to an embodiment of the present disclosure. Referring to FIG. 1, the user authentication apparatus 100 includes a display unit 110, a camera 120, a storage 130, a transceiver 140, and a control unit 150.

The following description is made on respective functions of elements illustrated in FIG. 1.

A touch sensor may be attached to the display unit 110 and thus a user may touch a screen to input data. When a user authentication application displayed on the screen is touched, a user authentication setting window through which a password/pattern and a scan of a facial image may be entered to authenticate a user may be displayed on the display unit 110. When a password registration function for registering the password/pattern is selected in the user authentication setting window, a password/pattern input window may be displayed. At this point, if a face registration function for registering a facial image is selected, a camera capture function on a screen may be touched to scan a face of the user.

Moreover, after the user authentication setting is completed, if the user attempts to access the device, a user authentication window including a face authentication window and a password/pattern authentication window for user authentication may be displayed.

The camera 120 may scan the user's face when the camera capture function of the display unit 110 is selected.

The storage 130 may store the user authentication application and may store a registered password/pattern and a registered facial image.

If the user authentication application is not stored in the storage 130, the transceiver 140 may access a user authentication application from a remote server (not shown) and the apparatus 100 may receive the user authentication application over a communication network (not shown).

When the user authentication application displayed by the display unit 110 is selected by the user, the control unit 150 may execute the user authentication application stored in the storage 130 to display the user authentication setting window on the display unit 110. When a password setting function is selected by the user, the control unit 150 may provide the password/pattern input window on the display unit 110. For example, when the same password/pattern is inputted two times, the password may be registered and, when the same facial image is inputted two times, the input facial image may be registered. Here, the number of times may vary by less or more.

The user authentication apparatus 100 of FIG. 1 may be included in a terminal such as a smart phone or a tablet PC which may previously store the user authentication application or alternatively the application may be accessed from a remote server to receive the user authentication application. In addition, the password/pattern registration function may be provided by the smart phone or the tablet PC and the face registration function may be performed by executing the user authentication application. In this case, the smart phone or the tablet PC may access the application from the remote server to receive the user authentication application and register a face.

FIG. 2 is a flowchart describing a user authentication method according to an embodiment of the present disclosure. A password/pattern and a facial image are preregistered in the user authentication apparatus 100 and stored in the storage 130 through the above-described procedure. In this case, an operation in which a user authentication window is displayed is described with respect to FIG. 2.

At 200, when a user attempts to authenticate for using the user authentication apparatus 100, the camera 120 is activated and the display unit 110 displays the face authentication window through which a face is scanned by the camera 120 to obtain a scanned facial image. For example, when the scanned image includes another image as well as the facial image, the user authentication apparatus 100 may obtain the scanned facial image by a knowledge-based method, a feature-based method, or a template-matching method.

At 210, the user authentication apparatus 100 compares the scanned facial image with a facial image registered in the storage 130. Here, the user authentication apparatus 100 may extract characteristic information of the scanned facial image and compare the characteristic information of the scanned facial image and characteristic information of the registered facial image.

At 220, the user authentication apparatus 100 determines whether the scanned facial image matches the registered facial image in the storage 130. When it is determined at 220 that the scanned facial image matches the facial image registered in the storage 130, the user authentication apparatus 100 is unlocked at 230.

When it is determined at 220 that the scanned facial image does not match the face registered in the storage 130, the user authentication apparatus 100 displays the password/pattern authentication window and, when a password/pattern is inputted through the password/pattern authentication window, the user authentication apparatus 100 obtains the password/pattern at 240.

At 250, the user authentication apparatus 100 determines whether the input password/pattern matches a registered password/pattern stored in the storage 130.

When it is determined at 250 that the input password/pattern matches the registered password/pattern in the storage 130, the user authentication apparatus 100 adds the scanned facial image to a facial image group registered in the storage 130 to update the previously registered facial image group at 260 and proceeds to step 230. In this case, the user authentication apparatus 100 may add the newly scanned facial image to the registered facial image group while keeping the existing registered facial image or may remove the existing registered facial image by replacing the existing registered facial image with the newly scanned facial image.

When it is determined at 250 that the input password/pattern matches the registered password/pattern in the storage 130, the user authentication apparatus 100 may directly proceeds to step 260. Alternatively, however, the display unit 110 may display a message requesting approval as to whether to perform an update. When the user approves the update, the user authentication apparatus 100 may perform the operation at 260. When it is determined at 250 that the input password/pattern does not match the registered password/pattern in the storage 130, the user authentication apparatus 100 ends the operation.

As described above, when a scanned facial image does not match a registered facial image, the user authentication method according to an embodiment of the present disclosure compares an inputted password/pattern and a registered password/pattern and, if the inputted password/pattern matches the registered password/pattern, the user authentication method adds the scanned facial image to the registered facial image group to update the existing registered facial image and unlocks the device. Accordingly, in subsequent user authentications, a face recognition operation may be performed by using the updated facial image of the user so as to enhance a face recognition rate of success.

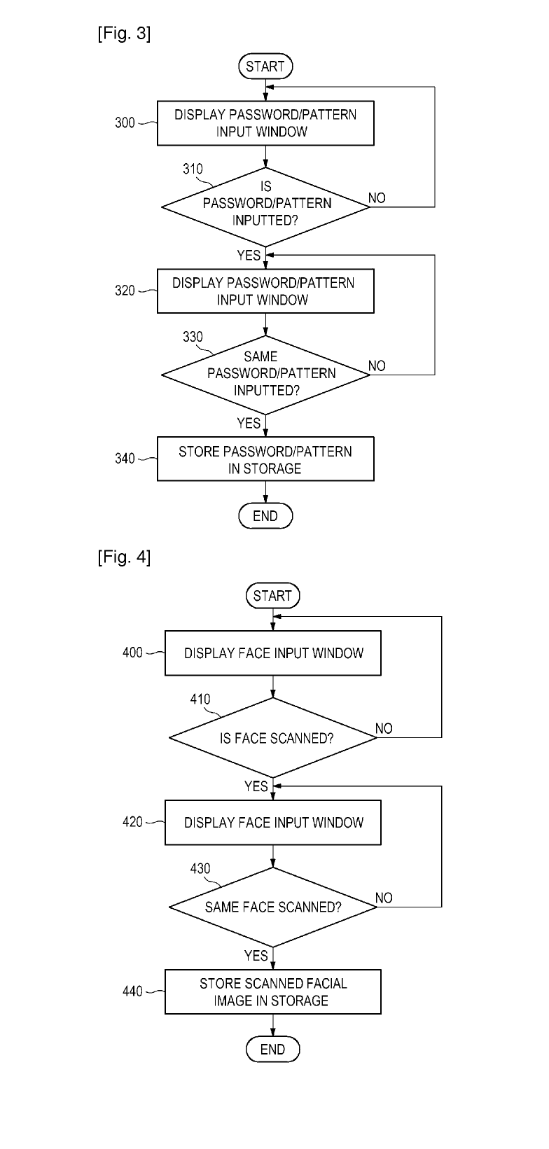

FIG. 3 is a flowchart for describing an operation of registering a password/pattern according to an embodiment of the present disclosure. When the password/pattern registration function of the user authentication setting window displayed by the display unit 110 is selected by a user, the operation of registering the password/pattern may be performed.

At 300, the password/pattern input window is displayed.

At 310, it is determined whether a password/pattern is inputted thereto.

When the password/pattern is inputted, the password/pattern input window is displayed again at 320.

At 330, it is determined whether the same password/pattern is inputted thereto.

When the same password/pattern is inputted, the password/pattern is stored in the storage 130 at 340.

When it is determined at 310 that the password/pattern is not inputted, the process proceeds to the operation at 300. When it is determined at 330 that the same password/pattern is not inputted, the process proceeds to the operation at 320.

In the method of registering a password/pattern according to an embodiment of the present disclosure, a registered password/pattern may be stored in the storage 130 when the password/pattern is input at least two times. However, as described above, the number of times may vary by less or more.

FIG. 4 is a flowchart for describing a facial image registration operation according to an embodiment of the present disclosure. When the facial image registration function of the user authentication setting window displayed by the display unit 110 is selected by a user, the face registration operation may be performed.

At 400, a face input window is displayed.

At 410, it is determined whether a face is scanned.

When it is determined at 410 that the face is to be scanned the face input window is displayed again at 420.

At 430, it is determined whether the face is scanned.

When it is determined at 430 that the face is scanned, the scanned facial image is stored in the storage 130 at 440.

When it is determined at 410 that a face is not scanned, the process proceeds to the operation at 400. When it is determined at 430 that the same face has not been scanned, the process proceeds to the operation at 420.

In the face registration method of an embodiment of the present disclosure, a facial image may be registered in the storage 130 by being scanned at least two times. However, as described above, the number of times may vary by less or more.

In the user authentication method according to an embodiment of the present disclosure, the operation (operation 210 of FIG. 2) that compares a scanned facial image with a registered facial image in the storage may be performed by comparing characteristic information of the scanned facial image and characteristic information of the registered facial image. Here, the characteristic information may include a plurality of feature points or a plurality of feature point descriptors. The feature points may include a face, eyes, eyebrows, a nose, and a mouth and the feature point descriptors may include descriptors of extracted feature points. Each of the descriptors may be a vector value.

The user authentication apparatus according to an embodiment of the present disclosure may be applied to a door lock device for authenticating a plurality of users as well as smart phones or tablet PCs used for authenticating a user.

The above-described embodiments of the present disclosure can be implemented as computer readable codes in a computer readable medium. The computer readable recording medium may include a program instruction, a local data file, a local data structure, or a combination thereof. The computer readable recording medium may be specific to exemplary embodiments of the present disclosure or commonly known to those of ordinary skill in computer software. The computer readable recording medium includes all types of recordable media in which computer readable data are stored. Examples of the computer readable recording medium include a magnetic medium, such as a hard disk, a floppy disk and a magnetic tape, an optical medium, such as a CD-ROM and a DVD, a magneto-optical medium, such as a floptical disk, and a hardware memory, such as a ROM, a RAM and a flash memory, specifically configured to store and execute program instructions. Examples of the program instruction include machine code, which is generated by a compiler, and a high level language, which is executed by a computer using an interpreter and so on. The above-described hardware apparatus may be configured to operate as one or more software modules for performing the operation of the present disclosure, and the reverse case is similar.

While certain embodiments have been described, these embodiments have been presented by way of example only, and are not intended to limit the scope of the disclosures. Indeed, the novel methods and apparatuses described herein may be embodied in a variety of other forms; furthermore, various changes, modifications, corrections, and substitutions with regard to the embodiments described herein may be made without departing from the spirit of the disclosures.

Therefore, the accompanying claims and their equivalents including the foregoing modifications are intended to cover the scope and spirit of the disclosures, and are not limited by the present disclosures.

1. A method for authenticating a user, comprising:
(a) scanning a face by operating a camera to obtain a scanned facial image;
(b) extracting characteristic information on the scanned facial image, comparing the extracted characteristic information with characteristic information on a facial image registered in a storage, ad if there is a mismatch therebetween, requesting a password or a pattern; and
(c) if the password or pattern matches a password or pattern registered in the storage in the comparison, unlocking a user device, and adding the characteristic information on the scanned facial image to the storage to effect an update,
wherein the step (c) comprises,
(c1) if the password or pattern matches a password or pattern registered in the storage in the comparison, unlocking the user device;
(c2) requesting approval from a user as to whether to add the characteristic information on the scanned facial image to effect an update; and
(c3) upon receiving the user's approval, adding the characteristic information on the scanned facial image to the storage to effect an update.

2. The method according to claim 1, wherein the step \textcircled{c} comprises, if the password or pattern matches a password or pattern registered in the storage, unlocking the user device, and effecting an update by replacing the characteristic information on the facial image registered in the storage with the characteristic information on the scanned facial image.

3. The method according to claim 1, wherein the step (c) comprises, if the password or pattern matches a password or pattern registered in the storage, unlocking the user device, and effecting an update by adding the characteristic information on the scanned facial image to a group of facial images registered in the storage.

4. The method according to claim 1, wherein the characteristic information comprises characteristic features.

5. The method according to claim 4, wherein the characteristic information comprises descriptors of the characteristic features.

6. The method according to claim 4, further comprising, before the step (a), registering the password or pattern and the facial image in the storage, wherein registering the password or pattern and the facial image in the storage comprises inputting the password or pattern n times and scanning the face at least m times to register the password or pattern and the facial image.

7. The method according to claim 6, wherein registering the password or pattern and the facial image in the storage comprises extracting characteristic information on the registered facial image and storing the characteristic information on the registered facial image in the storage.

8. An apparatus for authenticating a user, the apparatus comprising:
a storage for storing a registered password or pattern and characteristic information on a registered facial image;
a camera for scanning a face;
a display unit for inputting a password or pattern and displaying a face authentication window and a password or pattern authentication window; and
a control unit for providing the face authentication window to the display unit, operating the camera for authenticating a facial image inputted through the face authentication window to scan the face and obtain the facial image of the scanned face, extracting characteristic information on the scanned facial image, unlocking a device if the characteristic information on the scanned facial image matches the characteristic information on the registered facial image in comparison therebetween, providing the password or pattern authentication window to the display unit if the characteristic information on the scanned facial image mismatches the characteristic information on the registered facial image in comparison therebetween, and upon inputting the password or pattern through the password or pattern authentication window, comparing the inputted password or pattern with the registered password or pattern to unlock the device if there is a match therebetween in the comparison,
wherein the control unit adds the characteristic information on the scanned facial image to the storage to effect an update,
wherein the control unit, before effecting an update by adding the characteristic information on the scanned facial image to the storage, displays a message on the display unit, the message requesting approval from a user as to whether to add the characteristic information on the scanned facial image to effect an update, and upon receiving the user's approval, adds the characteristic information on the scanned facial image to the storage.

9. The apparatus according to claim 8, wherein if the password or pattern matches a password or pattern registered in the storage, the control unit unlocks the device, and effecting an update by replacing the characteristic information on the facial image registered in the storage with the characteristic information on the scanned facial image.

10. The apparatus according to claim 8, wherein if the password or pattern matches a password or pattern registered in the storage, the control unit unlocks the device, and an update is effected by adding the characteristic information on the scanned facial image to a group of facial images registered in the storage.

11. The apparatus according to claim 8, wherein the storage stores a user authenticating application and the control unit runs the user authenticating application if the user requests access to the user authenticating apparatus.

12. The apparatus according to claim 11, wherein the control unit provides a user authentication setting window by running the user authenticating application and provides a function for registering the password or pattern and a function for registering the facial image through the user authentication setting window; and
wherein the display unit displays the user authenticating setting window and displays the function for registering the password or pattern and the function for registering the face.

13. The apparatus according to claim 12, wherein the control unit provides a password or pattern input window n times on the display unit if the function for registering the password or pattern is selected and stores the password or pattern in the storage as the registered password or pattern if the same password or pattern is inputted n times through the password or pattern input window, and wherein the control unit operates the camera and provides a face input window m times on the display unit if the function for registering a face is selected and extracts the facial characteristic information to store as the characteristic information on the registered facial image if the same face is inputted m times on the face input window.

14. The apparatus according to claim 11, further comprising a transceiver for connecting to a user authenticating application providing server to download from the user authenticating application providing server that provides the user authenticating application.

15. The apparatus according to claim 8, wherein the characteristic information comprises characteristic features.

16. The apparatus according to claim 15, wherein the characteristic information comprises descriptors of the characteristic features.

17. A computer readable recording medium storing a computer program thereon that is executed to implement operations comprising:
(a) scanning a face by operating a camera to obtain a scanned facial image;
(b) extracting characteristic information on the scanned facial image, comparing the extracted characteristic information with characteristic information on a facial image registered in a storage, ad if there is a mismatch therebetween, requesting a password or a pattern; and
(c) if the password or pattern matches a password or pattern registered in the storage in the comparison, unlocking a user device, and adding the characteristic information on the scanned facial image to the storage to effect an update, wherein the step (c) comprises,
(c1) if the password or pattern matches a password or pattern registered in the storage in the comparison, unlocking the user device;
(c2) requesting approval from a user as to whether to add the characteristic information on the scanned facial image to effect an update; and
(c3) upon receiving the user's approval, adding the characteristic information on the scanned facial image to the storage to effect an update.

18. The computer readable recording medium of claim 17, storing a computer program thereon that is executed to implement operations comprising:
wherein the step (c) comprises, if the password or pattern matches a password or pattern registered in the storage, unlocking the user device, and effecting an update by replacing the characteristic information on the facial image registered in the storage with the characteristic information on the scanned facial image.

19. The computer readable recording medium of claim 17, storing a computer program thereon that is executed to implement operations comprising:
wherein the step (c) comprises, if the password or pattern matches a password or pattern registered in the storage, unlocking the user device, and effecting an update by adding the characteristic information on the scanned facial image to a group of facial images registered in the storage.

20. The computer readable recording medium of claim 17, storing a computer program thereon that is executed to implement operations comprising:
the characteristic information comprises characteristic features.

21. The computer readable recording medium of claim 20, storing a computer program thereon that is executed to implement operations comprising:
wherein the characteristic information comprises descriptors of the characteristic features.

22. The computer readable recording medium of claim 20, storing a computer program thereon that is executed to implement operations further comprising, before the step (a), registering the password or pattern and the facial image in the storage, wherein registering the password or pattern and the facial image in the storage comprises inputting the password or pattern n times and scanning the face at least m times to register the password or pattern and the facial image.

23. The computer readable recording medium of claim 22, storing a computer program thereon that is executed to implement operations comprising:
wherein registering the password or pattern and the facial image in the storage comprises extracting characteristic information on the registered facial image and storing the characteristic information on the registered facial image in the storage.
